(19) United States
(12) Patent Application Publication
(10) Pub. No.: US 2007/0077184 A1
(43) Pub. Date: Apr. 5, 2007

(54) Environmental dynamic leaching/extraction device

(75) Inventors: Chung-Chih Chen, Taichung County (TW); Chin-Ying Tsai, Chiayi County (TW); Chia-Ching Chou, Taipei City (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsin Chu (TW)

(21) Appl. No.: 11/320,651

(22) Filed: Dec. 30, 2005

(30) Foreign Application Priority Data
Sep. 30, 2005 (TW) 94134168

(51) Int. Cl. B01J 19/00

(52) U.S. Cl. 422/129

(57) ABSTRACT

The present invention discloses an environmental dynamic leaching/extraction device, including: a sample tank for fixing a sample provided therein; a feeding tank containing feed solution; a feeding tank pump for providing power to drive the feed solution of the feeding tank into the sample tank; a pH value adjusting solution containing acid solution and alkaline solution; a pump for providing power to drive the acid solution and alkaline solution contained in the pH value adjusting solution into the sample tank; a pH value meter connected to the sample tank to detect the pH value of the solution in the sample tank; and a plurality of collecting buckets for collecting the extraction solution leached out of the sample tank.

### BACKGROUND OF THE INVENTION

1. Field of the Invention

The present invention relates to an extraction device, and more particularly to an environmental dynamic leaching/extraction device operated by an automatic control system.

2. Description of the Related Art

General leaching/extraction methods are operating in static mode, and current detecting methods are leaching/extraction for total quantity and toxicity characteristic leaching procedure (TCLP). These methods, however, cannot correctly reflect the actual situations in a real environment. On the other hand, the conventional dynamic leaching/extraction method and standard made by European Committee for Standardization (CEN) takes samples manually, the main disadvantage is very time-consuming and needs high labor for operation.

Current detecting standards for environmental influence adopt TCLP to make the leaching/extraction test. Further, the environmental leaching/extraction test apparatuses adopted in Europe are based on manual sampling and have no automatic and modular control functions. There is therefore a need for an environmental leaching/extraction test device, which is designed to have an automatic module to control the sample feeding and can effectively collect via proper operations the necessary extraction solution for dynamic environmental analysis.

### SUMMARY OF THE INVENTION

Environmental dynamic leaching/extraction method is a novel and non-obvious technology developed and researched recently. The experimental data obtained by this method is objective and reasonable, and can estimate the environmental impacts for 100 years. With the dynamic leaching/extraction testing technology, the inorganic/organic diffusion simulation of granular or agglomerated material under a required environment can be detected, in order to estimate the influence to the environment under required conditions.

It is one object of the present invention to provide an environmental dynamic leaching/extraction device, which includes a sample tank for fixing a sample to reduce the error in the reaction between the feed solution of the feeding tank and the sample due to the incomplete contact therebetween.

It is another object of the present invention to provide an environmental dynamic leaching/extraction device having an automatic modular design.

It is still another object of the present invention to provide an environmental dynamic leaching/extraction device, which can make a rapid assembly and an automatic sampling based on the required detecting process, in order to save labor and cost.

It is still another object of the present invention to provide an environmental dynamic leaching/extraction device having an automatic collection and distribution system, which can collect the leached extraction solution after the reaction, in order to solve the problem in collection resulting from that the experiment time is excessively long.

To achieve the above objects, the environmental dynamic leaching/extraction device according to the present invention comprises: a sample tank for fixing a sample provided therein; a feeding tank containing feed solution; a feeding tank pump for providing power to drive the feed solution of the feeding tank into the sample tank; a pH value adjusting solution containing acid solution and alkaline solution; a pump for providing power to drive the acid solution and alkaline solution contained in the pH value adjusting solution into the sample tank; a pH value meter connected to the sample tank to detect the pH value of the solution in the sample tank; and a plurality of collecting buckets for collecting the extraction solution leached out of the sample tank. The feeding tank pump will drive the feed solution of the feeding tank into the sample tank via a pipe, the pump will drive the acid solution and alkaline solution contained in the pH value adjusting solution into the sample tank via another pipe, the above mixed solutions flowed into the sample tank will have a sufficient reaction with the sample, and then the leached extraction solution will flow to the plurality of collecting buckets via a splitting pipe.

Preferably, the acid solution of the pH value adjusting solution comprises nitric acid and sulfuric acid.

Preferably, the alkaline solution of the pH value adjusting solution comprises potassium hydroxide and sodium hydroxide.

Preferably, the sample tank further comprises a covering plate, a movable plate, and a plurality of movable bolts. The covering plate is disposed on the top of the sample tank, and the movable bolts will pass through the covering plate and connect the movable plate.

Preferably, lower fixing ribs are further disposed on the bottom of the sample tank, in order to lift and fix the sample; and upper fixing ribs are further disposed beneath the bottom of the movable plate, in order to fix the sample.

Preferably, the covering plate is provided with a plurality of holes.

Preferably, the movable plate is provided with holes.

Preferably, the bottom of the sample tank is provided with holes.

Preferably, the pipes and the splitting pipe further comprise a plurality of electromagnetic valves, in order to control the flowing directions of the solutions flowing through the pipes and the splitting pipe.

### BRIEF DESCRIPTION OF THE DRAWINGS

FIG. 1 is a block diagram of the environmental dynamic leaching/extraction device according to the present invention.

FIG. 2 is a cross-sectional view of the sample tank.

### DETAILED DESCRIPTION OF THE PREFERRED EMBODIMENTS

Although the present invention has been described in considerable detail with reference to certain preferred embodiments thereof, however prior to this description, it is should to be understood that those skilled in the art can easily make changes to the present invention described herein and the same performance as the present invention is obtained. Therefore, it is to be understood that the following description is a general disclosure to those skilled in the art and is not restrictive of the present invention.

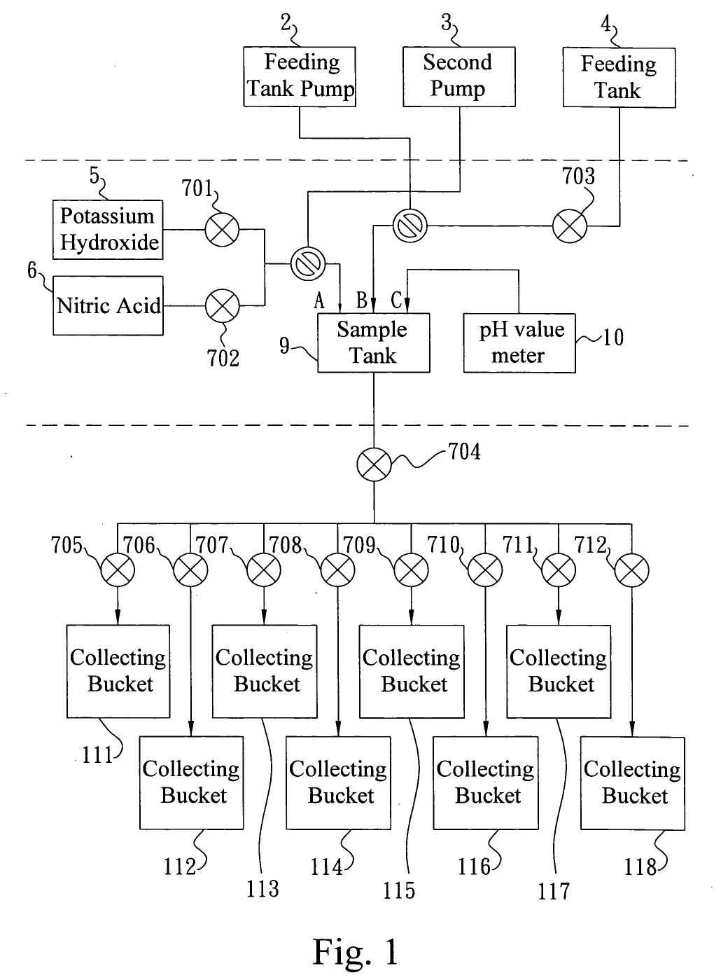

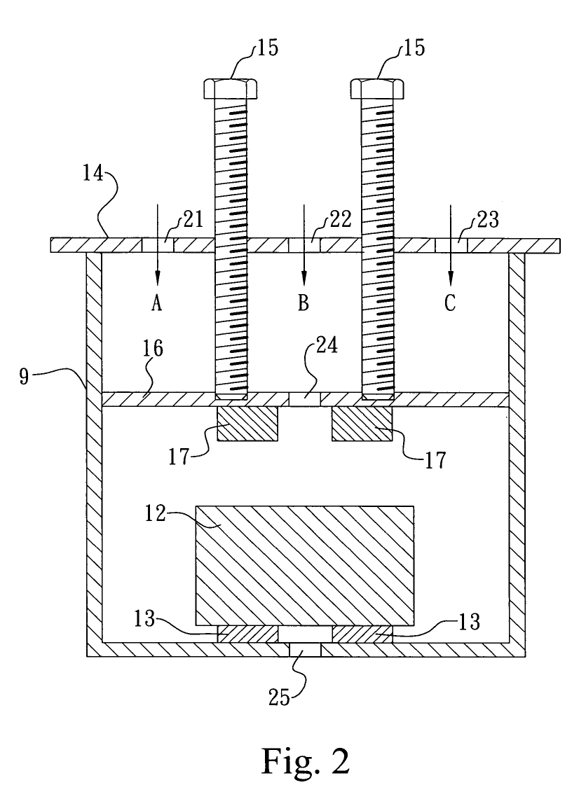

Referring to FIG. 1 and FIG. 2 for a block diagram of the environmental dynamic leaching/extraction device according to the present invention and a cross-sectional view of the sample tank. The environmental dynamic leaching/extraction device according to the present invention comprises: a sample tank 9 for fixing a sample 12 provided therein; a feeding tank 4 containing feed solution; a feeding tank pump 2 for providing power to drive the feed solution of the feeding tank 4 into the sample tank 9; a pH value adjusting solution containing acid solution and alkaline solution, in a preferred embodiment of the present invention, the alkaline solution of the pH value adjusting solution is potassium hydroxide 5 and the acid solution of the pH value adjusting solution is nitric acid 6; a pump 3 for providing power to drive the acid solution and alkaline solution contained in the pH value adjusting solution into the sample tank 9; a pH value meter 10 connected to the sample tank 9 to detect the pH value of the solution in the sample tank 9; and a plurality of collecting buckets 111-118, for collecting the extraction solution leached out of the sample tank 9.

Continuing referring to FIG. 1, the feeding tank pump 2 will drive the feed solution of the feeding tank 4 into the sample tank 9 via the pipe B (referring to FIG. 2, the pipe B is connected to a hole 22), and the electromagnetic valve 703 located in the pipe B is electrically connected to the automatic model and controls the flowing direction of the feed solution flowing through the pipe B.

The pump 3 will drive the potassium hydroxide 5 and the nitric acid 6 contained in the pH value adjusting solution into the sample tank 9 via the pipe A (referring to FIG. 2, the pipe A is connected to a hole 21), and the electromagnetic valves 701, 702 located in the pipe A are electrically connected to the automatic model and respectively control the flowing directions of the potassium hydroxide 5 and nitric acid 6 solutions flowing through the pipe A.

After the sufficient mixing of the above solutions flowed into the sample tank 9 via the pipe A and pipe B, the pH value meter 10 can detect the pH value of the solution in the sample tank 9 via the pipe C (referring to FIG. 2, the pipe C is connected to a hole 23), and then the operator can appropriately introduce the potassium hydroxide 5 and the nitric acid 6 into the sample tank 9 depending on the pH value of the solution in the sample tank 9, in order to make adjustment to obtain the required pH value.

Continuing referring to FIG. 2, the sample tank 9 further comprises a covering plate 14, a movable plate 16, and a plurality of movable bolts 15. The covering plate 14 is disposed on the top of the sample tank 9, and the movable bolts 15 will pass through the covering plate 14 and connect the movable plate 16. A plurality of lower fixing ribs 13 are further disposed on the bottom of the sample tank 9, in order to lift and fix the sample 12; and a plurality of upper fixing ribs 17 are further disposed beneath the bottom of the movable plate 16, in order to fix the sample 12.

When the movable bolts 15 are locked, the movable plate 16 will lower down, and the upper fixing ribs 17 disposed beneath the bottom of the movable plate 16 will gradually approach the sample 12 and fix it; on the other hand, when the movable bolts 15 are released, the movable plate 16 will lift up, and the upper fixing ribs 17 disposed beneath the bottom of the movable plate 16 will gradually move away from the sample 12.

The mixed solutions flowed into the sample tank 9 via the pipe A and pipe B will flow to the lower part of the sample tank 9 via the hole 24 and will make a sufficient reaction with the sample 12, and then the leached extraction solution will respectively flow to a plurality of collecting buckets 111-118 via a hole 25 and a splitting pipe, wherein a plurality of electromagnetic valves 704-712 disposed on the splitting pipe are electrically connected to the automatic model and control the flowing directions of the extraction solutions flowing through the splitting pipe.

Although the preferred embodiment of the present invention has been described in the above, however it is not intended to limit the present invention. Those skilled in the art can easily make alterations and modifications without departing from the spirit and scope of the present invention. For example, in the acid solution contained in the pH value adjusting solution of the present invention, the nitric acid solution may be replaced by the sulfuric acid solution, and in the alkaline solution contained in the pH value adjusting solution of the present invention, the potassium hydroxide solution may be replaced by the sodium hydroxide solution, and the same performance can be obtained. Therefore, the protected scope of the present invention is defined by the appended claims.

What is claimed is:

1. An environmental dynamic leaching/extraction device, comprising:
a sample tank for fixing a sample provided therein;
a feeding tank containing feed solution;
a feeding tank pump for providing power to drive the feed solution of said feeding tank into said sample tank;
a pH value adjusting solution containing acid solution and alkaline solution;
a pump for providing power to drive the acid solution and alkaline solution contained in said pH value adjusting solution into said sample tank;
a pH value meter connected to said sample tank to detect the pH value of the solution in said sample tank; and
a plurality of collecting buckets for collecting the extraction solution leached out of said sample tank;
wherein said feeding tank pump will drive the feed solution of said feeding tank into said sample tank via a pipe, said pump will drive the acid solution and alkaline solution contained in said pH value adjusting solution into said sample tank via another pipe, the above mixed solutions flowed into said sample tank will have a sufficient reaction with the sample, and then the leached extraction solution will flow to said plurality of collecting buckets via a splitting pipe.

2. The environmental dynamic leaching/extraction device as claimed in claim 1, wherein the acid solution of said pH value adjusting solution comprises nitric acid and sulfuric acid.

3. The environmental dynamic leaching/extraction device as claimed in claim 1, wherein, the alkaline solution of said pH value adjusting solution comprises potassium hydroxide and sodium hydroxide.

4. The environmental dynamic leaching/extraction device as claimed in claim 1, wherein said sample tank further comprises a covering plate, a movable plate, and a plurality of movable bolts, said covering plate is disposed on the top of said sample tank, and said movable bolts will pass through said covering plate and connect said movable plate.

5. The environmental dynamic leaching/extraction device as claimed in claim 1, wherein lower fixing ribs are further disposed on the bottom of said sample tank, in order to lift and fix the sample; and upper fixing ribs are further disposed beneath the bottom of said movable plate, in order to fix the sample.

6. The environmental dynamic leaching/extraction device as claimed in claim 4, wherein said covering plate is provided with a plurality of holes.

7. The environmental dynamic leaching/extraction device as claimed in claim 4, wherein said movable plate is provided with holes.

8. The environmental dynamic leaching/extraction device as claimed in claim 1, wherein the bottom of said sample tank is provided with holes.

9. The environmental dynamic leaching/extraction device as claimed in claim 1, wherein said pipes and said splitting pipe further comprise a plurality of electromagnetic valves, in order to control the flowing directions of the solutions flowing through said pipes and said splitting pipe.
